(19) United States
(12) Patent Application Publication
(10) Pub. No.: US 2016/0092797 A1
(43) Pub. Date: Mar. 31, 2016

(54) ACCESS TO ATTRACTIONS

(71) Applicants: William R. Clarke, San Jose, CA (US); Michael Songnam Hwang, Sunnyvale, CA (US); April Lynn Van Scherpe, San Jose, CA (US); Teresa Elizabeth Bedel, Redwood City, CA (US); Megan Marie Williams, Santa Cruz, CA (US)

(72) Inventors: William R. Clarke, San Jose, CA (US); Michael Songnam Hwang, Sunnyvale, CA (US); April Lynn Van Scherpe, San Jose, CA (US); Teresa Elizabeth Bedel, Redwood City, CA (US); Megan Marie Williams, Santa Cruz, CA (US)

(21) Appl. No.: 14/502,716

(22) Filed: Sep. 30, 2014

(51) Int. Cl. G06Q 10/02; G06Q 20/14

(52) U.S. Cl. CPC G06Q 10/02; G06Q 20/14

(57) ABSTRACT

Methods and systems for improving access to an attraction are described. A user pays for a purchase using a service provider. The service provider generates a pass to an attraction associated with the purchase. The pass can designate a future time and an access code for accessing the attraction. When the user returns at the assigned future time, the right of the user to the attraction at the assigned time is validated with the pass, and the user is granted immediate access to the attraction.

### BACKGROUND

1. Field of the Invention

The present invention generally relates to methods of managing lines to various attractions, and more particularly to improving access to attractions.

2. Related Art

There are a number of circumstances where people have to wait in line to do something. At amusement parks, for example, a customer often needs to wait in line to ride an attraction, and the most popular attractions usually have the longest lines. Other situations where people have to wait in line are at banks, a bakery, at restrooms, at government offices, to buy tickets for shows or concerts, to gain admission to museums, or at any other place where the number of people arriving to take advantage of goods or services at any one time exceeds the speed at which any one customer or group of customers can be served. When such a situation occurs, a line forms.

Although customers wait in line, none prefer it. People feel that time spent in line is time wasted. A customer would much rather come back later when there is no line so that the customer can do other things instead of waiting in line. Accordingly, there is a need for decreasing the waiting in line.

### BRIEF DESCRIPTION OF THE FIGURES

FIG. 1 is a block diagram illustrating a system for improving access to an attraction according to an embodiment of the present disclosure;

FIG. 2 is a flowchart showing a method for improving access to an attraction according to an embodiment of the present disclosure; and

FIG. 3 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods that allow users to bypass or jump lines for attractions. A user may access an attraction in a manner that avoids standing in line and waiting. A user pays for a purchase using a service provider, and the user is assigned a pass to an attraction by the service provider. The pass in various embodiments designates a future time and an access code for accessing an attraction, or the user is pinged/notified when their opening is ready with the access code confirming their right to access. When the user returns at the assigned time, the right of the user to the attraction at the assigned time is validated with the pass, and the user is granted immediate access to the attraction. The right of the user may be a value added feature for which the user pays additional money (such as at the time of purchasing an item or service).

In certain embodiments, the user is provided with other relevant information that affects the user's decision whether to access the attraction. For example, information such as the capacity of the attraction, the volume of passes or tickets distributed for the attraction and/or wait times for the attraction may be provided to the user.

The systems and methods described herein are particularly useful in an environment where the number of users that desire to access an attraction is greater, at one or more times, than the capacity of the attraction. The term “attraction” as used herein means any location or presentation to which one or more users wish to gain access. The attraction may include a location at which a service is provided, such as a show, theater, restaurant or other food service, restroom, merchandise location, transportation, photobooth, and the like. The attraction may also include a geographic location such as a natural wonder, a museum, amusement park, carnival, concert, circus, sports event, conference, or the like.

Assigning a specific time for the user to access an attraction reduces the length of lines and the waiting time in lines. This allows the user to engage in other activities, and makes for a better user experience.

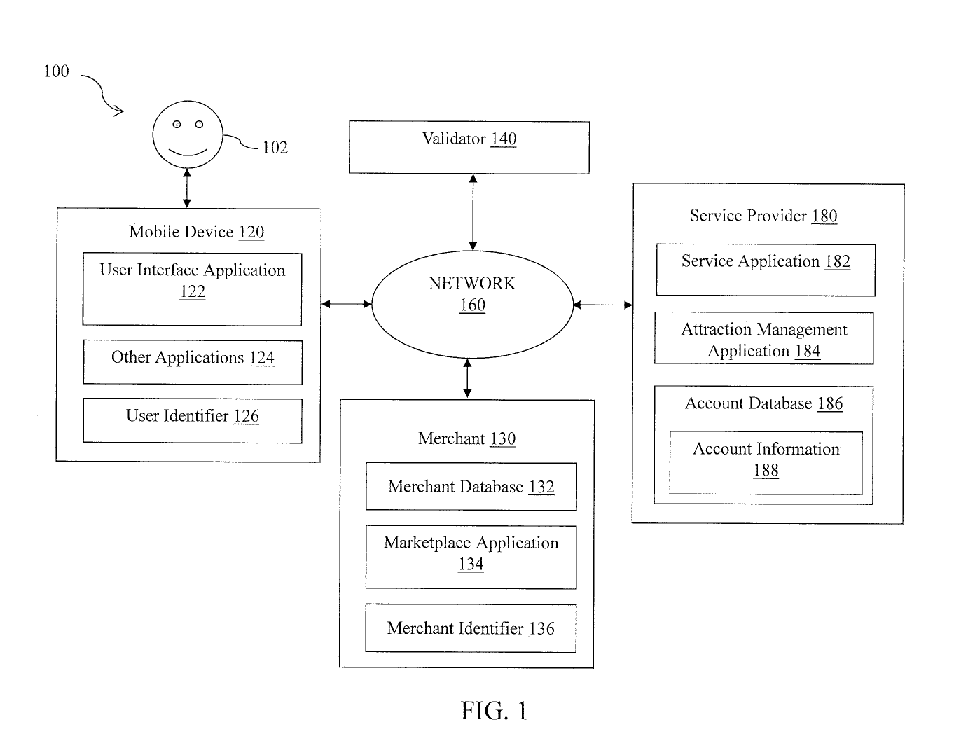

FIG. 1 shows one embodiment of a block diagram of a network-based system 100 adapted to improve access to an attraction using a mobile device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a mobile device 120 (e.g., a smartphone), a merchant server or device 130, a validator 140, and at least one service provider server or device 180 (e.g., network server device) in communication over the network 160. The network 160, in one embodiment, may each be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The mobile device 120, in various embodiments, may be implemented using any appropriate combination of hardware and/or software configured for wired and/or wireless communication over the network 160. The mobile device 120, in one embodiment, may be utilized by the user 102 to interact with the service provider server 180 and/or the validator 140 over the network 160. For example, the user 102 may conduct financial transactions (e.g., account transfers, bill payment, etc.) with the service provider server 180 via the mobile device 120, and validator 140 may validate the user's right to an attraction via the mobile device 120. In various implementations, the mobile device 120 may include a wireless telephone (e.g., cellular or mobile phone), a tablet, a wearable computing device, a personal computer, a notebook computer, and/or various other generally known types of wired and/or wireless computing devices.

The mobile device 120, in one embodiment, includes a user interface application 122, which may be utilized by the user 102 to conduct financial transactions (e.g., shopping, purchasing, bidding, etc.) or information transactions with the merchant server or device 130 or the service provider server 180 over the network 160. In one aspect, purchase expenses may be directly and/or automatically debited from an account related to the user 102 by the service provider when the user 102 uses the user interface application 122.

In one implementation, the user interface application 122 comprises a software program, such as a graphical user interface (GUI), executable by a processor that is configured to interface and communicate with the service provider server 180 and/or validator 140 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items) from the one or more merchant servers 130 via the service provider server 180.

The mobile device 120, in various embodiments, may include other applications 124 as may be desired in one or more embodiments of the present disclosure to provide additional features available to user 102. In one example, such other applications 124 may include security applications for implementing client-side security features, calendar application, contacts application, location-based services application, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The mobile device 120, in one embodiment, may include at least one user identifier 126, which may be implemented, for example, as operating system registry entries, cookies associated with the user interface application 122, identifiers associated with hardware of the mobile device 120, or various other appropriate identifiers. The user identifier 126 may include one or more attributes related to the user 102, such as personal information related to the user 102 (e.g., one or more user names, passwords, PIN numbers, photograph images, biometric IDs, addresses, phone numbers, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The one or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering items to the user 102 over the network 160. As such, each of the one or more merchant servers 130 may include a merchant database 132 for identification items for sale, which may be made available to the mobile device 120 for viewing and purchase by the user 102. In one or more embodiments, user 102 may complete a transaction such as purchasing the items via the service provider server 180.

Each of the merchant servers 130, in one embodiment, may include a marketplace application 134, which may be configured to provide information over the network 160 to the user interface application 122 of the mobile device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. In various embodiments, user 102 may conduct transactions (e.g., searching, selection, monitoring, purchasing, and/or providing payment for items) with each merchant server 130. The service provider server 180 can assist in providing payment for items over the network 160.

A merchant website may also communicate (for example, using merchant server 130) with the service provider through service provider server 180 over network 160. For example, the merchant website may communicate with the service provider in the course of various services offered by the service provider to merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of service provider as a payment intermediary. The merchant website may also have an account with the service provider.

The validator 140, in various embodiments, is a code reader/scanner that is operated by a merchant. The validator 140 is typically located adjacent the attraction, and may provide an estimated waiting time. The validator 140 reads or scans an access code displayed on the mobile device 120 to confirm that the user 102 has the right to access an attraction at a specific time. When the user 102 attempts to access the attraction, the user 102 presents the access code on the mobile device 120 to the validator 140 to gain access to the attraction. The validator 140 confirms that the information encoded in the access code match the current time and attraction before the user 102 is granted access to the attraction. In some embodiments, the user 102 can directly input the access code (e.g., alphanumeric code) in the validator 140 to gain access to the attraction.

In certain embodiments, the validator 140 is a human attendant employed by a merchant that reads information printed on a pass or presented on the mobile device 120 and verifies the information. The attendant may verify the assigned time or time range against the current time, a date of the pass against the current time, and the attraction for which the pass is issued.

The service provider server 180, in one embodiment, may be maintained by a transaction processing entity, which may provide processing for financial transactions and/or information transactions between the user 102, merchant server 130, and validator 140. As such, the service provider server 180 includes a service application 182, which may be adapted to interact with the mobile device 120, merchant server 130, and/or validator 140 over the network 160. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service provider server 180, in one embodiment, may be configured to maintain one or more user accounts and merchant accounts in an account database 186 each of which may include account information 188 associated with one or more individual users (e.g., user 102) and merchants, such as past purchases and attractions visited in the past. For example, account information 188 may include private financial information of user 102, such as one or more account numbers, passwords, credit card information, banking information, or other types of financial information, which may be used to facilitate financial transactions between user 102 and a merchant. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

In various embodiments, the service provider server 180 includes attraction management application 184. Attraction management application 184 manages the lines to one or more attractions. In various embodiments, attraction management application 184 receives a request for a pass to an attraction from the user 102 during a payment event (e.g., paying for an item or service in a checkout line). In one embodiment, attraction management application 184 communicates with the merchant server 130 or an external database to determine possible attractions for the user 102. Attraction management application 184 may access an account of the user 102 to check whether the user 102 is entitled to receive a pass for the attraction. For example, in some embodiments, the user 102 must have a certain amount of rewards or points, or have spent a certain amount of money before a pass is issued. In other embodiments, the user 102 may be requested to pay an additional amount of money to receive a pass. In one embodiment, the user 102 can pay a premium amount to access premium attractions (e.g., women-only restrooms). In yet other embodiments, the user 102 may be issued the pass without any conditions.

Attraction management application 184 can then generate a pass for the attraction that includes an appointment time and an access code. The pass in various embodiments is transmitted to the mobile device 120. When the pass is presented to the validator 140, the validator 140 reads the access code and, in some embodiments, transmits the access code back to the attraction management application 184 for verification. If the access code is verified, the user 102 is granted access to the attraction.

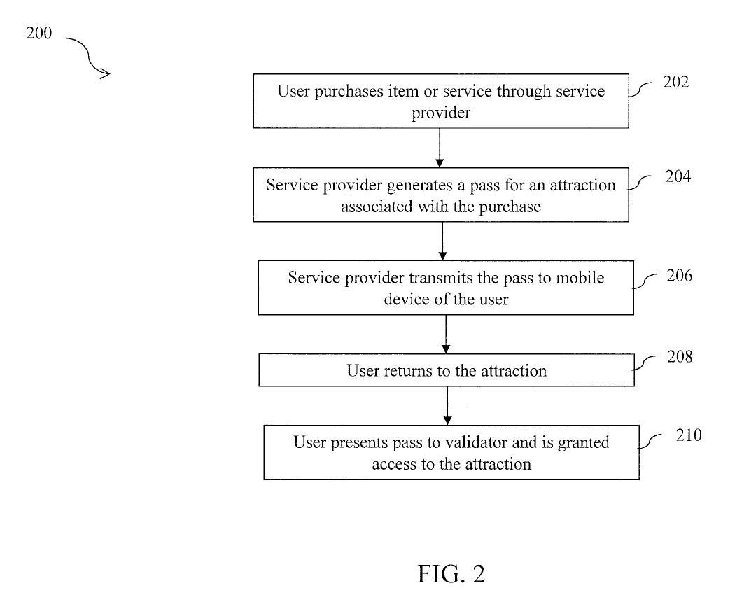

Referring now to FIG. 2, a flowchart 200 of a method for improving access to an attraction is illustrated according to an embodiment of the present disclosure. In various embodiments, the user 102 registers with a service provider, which runs a mobile application. Registration may include signing up for the service and agreeing to any terms required by the service provider, such as through a user device. In one embodiment, the user device is a mobile computing device, such as a smartphone, a PC, or a computing tablet. In other embodiments, registration may be done completely through the user device, partially through the user device, or without using the user device, such as through a phone call or in-person visit to a representative of the payment service provider.

The user may be requested to provider specific information for registration, such as, but not limited to, a name, address, phone number, email address, picture, a user name for the account, a password or PIN for the account, or other biometric identification such as a fingerprint. The type of information may depend on whether the user already has an account with the service provider. Requested information may be entered through the user device or other means, including voice or manual key entry. Once all the requested information is received and confirmed, the service provider may create an account for the user.

At step 202, the user 102 purchases one or more items or services from a merchant (e.g., a merchant associated with merchant device or server 130) through the service provider server 180. For example, the user 102 can enter a physical store of a merchant, select items, and pay for the purchase. The service provider server 180 processes the payment request. In various embodiments, the service provider server 180 stores information regarding the user 102's purchase.

The user 102, in various embodiments, may wish to access an attraction associated or linked with the purchase. For example, if the user 102 purchases food or drink, the attraction may be a restroom. In another example, if the user 102 purchases an amusement park ticket, the attraction may be a park ride or transportation into or out of the park. In yet another example, if the user 102 purchases a sports ticket, the attraction may be a souvenir shop or a concessions stand. In one other example, the user 102 purchases gas, and the attraction is a smog check service.

At step 204, the service provider server 180 generates a pass for the user 102 to access the attraction at a later time. Generation of the pass may be triggered manually by the user 102 or automatically by the server 180. For example, the user 102 may send a request through mobile device 120, such as by selecting a “Request Pass” button from a service provider application. In another example, mobile device 120 may be detected as being in a payment situation, such as entering a merchant store, entering a checkout line, or receiving a payment request from the merchant. In this embodiment, the server 180 may automatically display a message for a pass on the mobile device 120.

The service provider server 180, in certain embodiments, determines a list of possible attractions for the user 102 based on past attractions visited by the user 102, attractions that are located in the vicinity of the user 102, attractions visited by other users who purchased the same or similar item or service, attractions visited by friends or family of the user 102, attractions that the user may need or want based on the purchased item or service, etc. The user 102 may then be presented with the list of possible attractions and select one or more attractions he or she is interested in. In other embodiments, the user 102 enters the name of the attraction in a text field on the mobile device 120, and the service provider server 180 searches the names of attractions to determine which attraction the user 102 is interested in.

The pass, in various embodiments, provides a time assigned by the service provider server 180 during which the user 102 is entitled to access the attraction in the future. The assigned time may be a window or range of time (e.g., 30 minute to 2 hour window) or may be a specific time (e.g., 1:30 pm or 10:10 am). In some embodiments, if the user 102 does not show up at the attraction at the assigned time, he or she may be charged an additional fee. In certain embodiments, the service provider server 180 may provide a new time or time window to the user 102 when the user 102 fails to arrive at the attraction at the assigned time.

The amount of time between the time a pass is issued and the time at which the user 102 can utilize the attraction depends on a number of factors including the number of people who have already obtained passes, the capacity of the attraction, any delays related to the operation of the attraction, demographics of the users, the time of day, the day of the week, how many times the user has accessed the attraction, the type and number of purchases made by the user, and/or distance of the user from the attraction. For example, a user who is remotely located from a ride when making the request for a pass may have more time between the time the pass is issued and the assigned time than those located closer to the ride when the request is made. A user with young children may have less time between the time the pass is issued and the assigned time for access to restrooms and restaurants than a user with no children. In another example, the more money that is spent by the user at the merchant, the less time they have to wait between the time the pass is issued and the assigned time for certain attractions.

In some embodiments, the time assigned to the user 102 can be dynamically adjusted or changed based on the factors listed above. For example, a user who has purchased several drinks over a span of time can be moved closer to the front of the line or have higher priority for access to the restroom than a user who has only purchased a few drinks. On the other hand, a user who has accessed the restroom multiple times can be moved farther from the front of the line for access to the restroom than a user who has accessed the restroom only once or twice. In another example, a user with a disability may be given higher priority than a user without a disability so that the user without a disability is re-assigned a later time.

In addition to the assigned time, the pass may also include an access code. The access code is presented by the user 102 to the validator 140 at the assigned time to gain access to the attraction. The access code may be a numeric string, alpha string, alphanumeric string, or a barcode, such as a Quick Response (QR) code. In one embodiment, the access code includes a 4-8 character alphanumeric string and is entered by the user 102 in the validator 140. In another embodiment, the access code is a barcode that is scanned or read by the validator 140. The assigned time and attraction to be accessed are typically encoded in the access code.

In some embodiments, the user 102 is prevented from obtaining more than one pass for accessing an attraction at a single time. For example, only one pass can be associated with a single user at a time so that one user does not monopolize the attraction.

In other embodiments, the user 102 may only obtain a pass when the user 102 has not previously been issued a yet unused or unexpired pass. This scheme is to prevent users from obtaining multiple passes for a single attraction, preventing others from enjoying it, or to prevent users from reserving admittance to multiple attractions.

In certain embodiments, however, the user 102 may be permitted to obtain multiple passes to one or more attractions as long as certain conditions are met. For example, the attractions must be in different categories (e.g., a restaurant and an amusement park ride) or there must be a certain amount of time between passes issued to a single user for a single attraction (e.g., a user must wait at least 2 hours to access a ride a second time).

In various embodiments, the service provider server 180 is associated with more than one attraction. The service provider server 180 can be linked in a manner that permits verification that the user 102 accessing one attraction has not already been issued a pass entitling them to access the same attraction or another attraction.

At step 206, the service provider server 180 transmits the pass to the mobile device 120 of the user 102. At step 208, the user 102 returns to the attraction and seeks access to the attraction via, for example, a separate line. In various embodiments, the user 102 is alerted or reminded that the assigned time is approaching. For example, a 10-minute or 15-minute warning may be sent to the user 102 to allow sufficient time for the user 102 to travel to the attraction. In another embodiment, the user 102 sets up the number of reminders he or she would like to receive and the number of minutes before the assigned time at which each reminder starts.

At step 210, the user 102 presents the pass to the validator 140. In various embodiments, the user 102 presents the access code to a person who verifies the current time, the code, and the attraction for which the access code provides access. In some embodiments, the user 102 validates entitlement to access the attraction by scanning or inputting the access code on the validator 140. In various embodiments, the validator 140 may transmit the access code to the service provider server 180 for confirmation of correct time and attraction. If validated, the user 102 is permitted to access the attraction.

In an exemplary embodiment, validation is received in the form of a barcode image displayed on the mobile device 120. The user 102 uses the mobile device 120 at the entrance of the attraction to validate their access to the attraction by holding it up to the validator 140 (e.g., a barcode scanning device).

Advantageously, the methods and systems of the present disclosure permit one or more users to gain access to an attraction without having to wait in a standard line to access the attraction. This permits the user to engage in other activity instead of waiting in line, and provides a more enjoyable user experience.

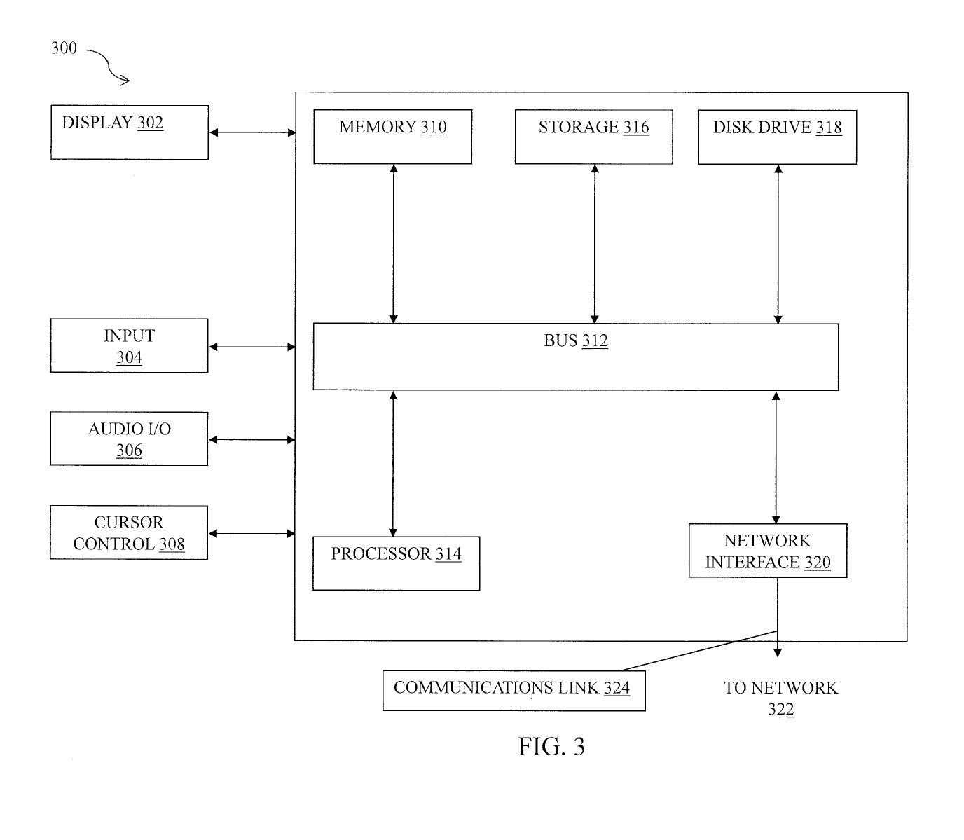

FIG. 3 is a block diagram of a computer system 300 suitable for implementing one or more embodiments of the present disclosure, including the mobile device 120, the merchant device or server 130, validator 140, and the service provider server 180. In various implementations, the mobile device 120, merchant device or server 130, and validator 140, and may comprise a mobile cellular phone, personal computer (PC), laptop, wearable computing device, etc. adapted for wireless communication, and the service provider server 180 may comprise a network computing device, such as a server. Thus, it should be appreciated that the devices 120, 130, 140, and 180 may be implemented as computer system 300 in a manner as follows.

Computer system 300 includes a bus 312 or other communication mechanism for communicating information data, signals, and information between various components of computer system 300. Components include an input/output (I/O) component 304 that processes a user (i.e., sender, recipient, service provider) action, such as selecting keys from a keypad/keyboard, selecting one or more buttons or links, etc., and sends a corresponding signal to bus 312. I/O component 304 may also include an output component, such as a display 302 and a cursor control 308 (such as a keyboard, keypad, mouse, etc.). The display 302 is may be configured to present a pass including an access code for access to an attraction. An optional audio input/output component 306 may also be included to allow a user to use voice for inputting information by converting audio signals. Audio I/O component 306 may allow the user to hear audio. A transceiver or network interface 320 transmits and receives signals between computer system 300 and other devices, such as another user device, a merchant server, or a service provider server via network 322. In one embodiment, the transmission is wireless, although other transmission mediums and methods may also be suitable. A processor 314, which can be a micro-controller, digital signal processor (DSP), or other processing component, processes these various signals, such as for display on computer system 300 or transmission to other devices via a communication link 324. Processor 314 may also control transmission of information, such as cookies or IP addresses, to other devices.

Components of computer system 300 also include a system memory component 310 (e.g., RAM), a static storage component 316 (e.g., ROM), and/or a disk drive 318. Computer system 300 performs specific operations by processor 314 and other components by executing one or more sequences of instructions contained in system memory component 310. For example, processor 314 can receive payment requests from a user, process the payment requests, determine possible attractions for a user, generate a pass for an attraction, transmit the pass to the user, and confirm access to the attraction. Logic may be encoded in a computer readable medium, which may refer to any medium that participates in providing instructions to processor 314 for execution. Such a medium may take many forms, including but not limited to, non-volatile media, volatile media, and transmission media. In various implementations, non-volatile media includes optical or magnetic disks, volatile media includes dynamic memory, such as system memory component 310, and transmission media includes coaxial cables, copper wire, and fiber optics, including wires that comprise bus 312. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 324 to the network (e.g., such as a LAN, WLAN, PTSN, and/or various other wired or wireless networks, including telecommunications, mobile, and cellular phone networks) may perform instruction sequences to practice the present disclosure in coordination with one another.

In view of the present disclosure, it will be appreciated that various methods and systems have been described according to one or more embodiments for improving access to an attraction.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing user financial information; and
one or more processors in communication with the memory device and operable to:
receive a payment request for an item or service from a user;
determine at least one attraction associated with the payment request;
generate a pass that provides access to the at least one attraction; and
cause the user to be granted access to the at least one attraction when the pass is presented at a future time.

2. The system of claim 1, wherein the one or more processors determine the at least one attraction based on past attractions visited by the user, attractions that are located in a vicinity of the user, attractions visited by others who purchased the same or similar item or service as the user, attractions visited by friends or family of the user, attractions that the user may need or want based on the item or service, or any combination thereof.

3. The system of claim 1, wherein the one or more processors are further operable to determine whether the user is entitled to receive the pass for the at least one attraction.

4. The system of claim 3, wherein the one or more processors determine whether the user is entitled to the pass based on rewards or points accumulated by the user, an amount spent by the user, or any combination thereof.

5. The system of claim 1, wherein the pass includes a future appointment time and an access code.

6. The system of claim 5, wherein the one or more processors is further operable to determine the future appointment time based on number of people who have already obtained passes, capacity of the at least one attraction, delays related to operation of the at least one attraction, demographics of users, how many times the user has accessed the at least one attraction, type and number of purchases made by the user, distance of the user from the at least one attraction, or any combination thereof.

7. The system of claim 1, wherein the one or more processors is further operable to transmit the pass to a mobile device of the user.

8. The system of claim 1, wherein the one or more processors is further operable to confirm the user's right to access the at least one attraction at the future time.

9. A method for improving access to an attraction, comprising:
receiving, by one or more hardware processors of a service provider, a request for a pass to an attraction from a user during a payment event;
generating, by the one or more hardware processors, the pass, wherein the pass includes a future appointment time and an access code;
transmitting, by the one or more hardware processors, the pass to a mobile device of the user; and
causing, by the one or more hardware processors, the user to be granted access to the attraction when the access code is presented at the future appointment time.

10. The method of claim 9, wherein the attraction comprises one or more of a restroom, concert, conference, sporting event, restaurant, museum, amusement park ride, photobooth, or merchandise store.

11. The method of claim 9, wherein the method further comprises receiving additional payment for the pass from the user.

12. The method of claim 11, wherein the additional payment is received at the time of the payment event.

13. The method of claim 9, wherein the method further comprises determining the future appointment time.

14. The method of claim 13, wherein the future appointment time is determined based on number of people who have already obtained passes, capacity of the at least one attraction, delays related to operation of the at least one attraction, demographics of users, how many times the user has accessed the at least one attraction, type and number of purchases made by the user, distance of the user from the at least one attraction, or any combination thereof.

15. A non-transitory machine-readable medium comprising instructions which, in response to a computer system, cause the computer system to perform a method comprising:
receiving a payment request for an item or service;
provide a list of possible attractions to a user based on the item or service;
receive a selection of one or more attractions from the list;
generate a pass for the one or more selected attractions; and
causing the user to be granted access to the one or more selected attractions when the pass is presented at a future time.

16. The non-transitory machine-readable medium of claim 15, wherein the pass includes a future appointment time and an access code.

17. The non-transitory machine-readable medium of claim 16, wherein the future appointment time is determined based on number of people who have already obtained passes, capacity of the at least one attraction, delays related to operation of the at least one attraction, demographics of users, how many times the user has accessed the at least one attraction, type and number of purchases made by the user, distance of the user from the at least one attraction, or any combination thereof.

18. The non-transitory machine-readable medium of claim 16, wherein the method further comprises transmitting an alert to the user that the future appointment time is approaching.

19. The non-transitory machine-readable medium of claim 16, wherein the method further comprises changing the future appointment time.

20. The non-transitory machine-readable medium of claim 15, wherein the method further comprises receiving additional payment for the pass.
